(19) United States
(12) Patent Application Publication
(10) Pub. No.: US 2017/0083843 A1
(43) Pub. Date: Mar. 23, 2017

(54) RISK EVALUATION IN PARALLELIZING PROJECTS

(71) Applicant: INTERNATIONAL BUSINESS MACHINES CORPORATION, Armonk, NY (US)

(72) Inventors: Hao Chen, Beijing (CN); Claudio Cozzi, Foster City, CA (US); Ya Bin Dang, Beijing (CN); Howard M. Hess, Winnetka, IL (US); Steven M. Kagan, Chicago, IL (US); Feng Li, Beijing (CN); Shao Chun Li, Beijing (CN); Jeffrey Lewis Robinson, Southfield, MI (US); Xin Zhou, Beijing (CN)

(21) Appl. No.: 14/955,382

(22) Filed: Dec. 1, 2015

Related U.S. Application Data
(63) Continuation of application No. 14/859,578, filed on Sep. 21, 2015.

(51) Int. Cl. G06Q 10/06

(52) U.S. Cl. CPC G06Q 10/06312

(57) ABSTRACT

Embodiments of the present invention may evaluate a conflict risk between parallel projects. According to one embodiment of the present invention, a dependency risk between a first project and a second project is determined based on an artifact submission history of a historical project. Then an overlap risk between the first and second projects is determined based on time schedules of the first and second projects. Next, a conflict risk between the first and second projects is evaluated based on the dependency risk and the overlap risk. Further, embodiments of the present invention may optimize the time schedules of parallel projects thereby enabling parallelization of projects.

### DOMESTIC PRIORITY

This application is a Continuation Application of legally related U.S. Ser. No. 14/859,578 filed Sep. 21, 2015, the contents of which in its entirety are herein incorporated by reference.

### BACKGROUND

With developments of the computer technology, daily performance of a modern enterprise increasingly depends on computer applications. Although each of these applications serves as an individual one, complex dependencies may exist among these applications. During the operation of the enterprise, existing applications may be upgraded and/or new applications may be developed to fix bugs, develop new functions so as to satisfy the users' requirements. For example, in a large enterprise such as a telecommunication provider, hundreds or thousands of Application Maintenance (AM) projects are launched to manage the time schedules and control qualities for various applications. Usually, these AM projects may be carried out in parallel and overlapped with each other. As a result, a conflict risk may arise among these overlapped AM projects.

For example, for the telecommunication provider, there may be separate applications for user management, credit management and the like. Although these applications may be developed in different projects by a same developing team or by different teams, these applications usually share some basic code such as a basic data input/output (I/O) library and/or a fundamental database. As such, if source code in the I/O library is modified by an engineer in one project, abnormity status may possibly arise if another project calls the modified code. In other words, modification to the same source code fragment by engineers in different AM projects may probably lead to a conflict. Resolving the potential conflict among these AM projects will take considerable costs in terms of time and manpower.

Although some project management tools have been proposed to generate time schedules for parallel projects with time overlaps therebetween, these tools cannot evaluate a potential conflict risk between the projects. In addition, the conflict risk between the projects depends on various aspects of these projects, and thus it is impossible to alleviate the risk by only rescheduling the time schedule of these projects.

### SUMMARY

In one aspect of the present invention, a computer-implemented method is proposed. According to the method, a dependency risk between a first project and a second project is determined based on an artifact submission history of a historical project. Then an overlap risk between the first and second projects is determined based on time schedules of the first and second projects. Next, a conflict risk between the first and second projects is evaluated based on the dependency risk and the overlap risk.

In another aspect of the present invention, a computing system is proposed. The computing system comprises a computer processor coupled to a computer-readable memory unit, the memory unit comprises instructions that when executed by the computer processor implements a method. In the method, a dependency risk between a first project and a second project is determined based on an artifact submission history of a historical project. Then an overlap risk between the first and second projects is determined based on time schedules of the first and second projects. Next, a conflict risk between the first and second projects is evaluated based on the dependency risk and the overlap risk.

In yet another aspect of the present invention, a computer program product is proposed. The computer program product is tangibly stored on a non-transient machine readable medium and comprises executable instructions which, when executed on an electronic device, cause the electronic device to determine a dependency risk between a first project and a second project based on an artifact submission history of a historical project; determine an overlap risk between the first and second projects based on time schedules of the first and second projects; and evaluate a conflict risk between the first and second projects based on the dependency risk and the overlap risk.

It is to be understood that the Summary is not intended to identify key or essential features of embodiments of the present invention, nor is it intended to be used to limit the scope of the present invention. Other features of the present invention will become easily comprehensible through the description below.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 schematically illustrates an example computer system/server 12 which is applicable to implement embodiments of the present invention;

FIG. 2 schematically illustrates a block diagram of dependencies between two projects in accordance with one embodiment of the present invention;

FIG. 3 schematically illustrates a block diagram for evaluating a conflict risk between two projects in accordance with one embodiment of the present invention;

FIG. 4 schematically illustrates a flowchart of a method for evaluating a conflict risk between two projects in accordance with one embodiment of the present invention;

FIG. 5 schematically illustrates example artifacts submitted in various tasks included in a historical project in accordance with one embodiment of the present invention;

FIG. 6 schematically illustrates a connected graph built based on associations between artifacts included in one historical project in accordance with one embodiment of the present invention;

FIG. 7 schematically illustrates a block diagram for identifying a time overlap between tasks in accordance with one embodiment of the present invention; and

FIG. 8 schematically illustrates a risk index indicating risk levels between overlapped tasks in accordance with one embodiment of the present invention.

Throughout the drawings, same or similar reference numerals represent the same or similar elements.

### DETAILED DESCRIPTION

Principle of the present invention will now be described with reference to some example embodiments. It is to be understood that these embodiments are described only for the purpose of illustration and help those skilled in the art to understand and implement the present invention, without suggesting any limitations as to the scope of the invention. The invention described herein can be implemented in various manners other than the ones describe below.

As used herein, the term “includes” and its variants are to be read as opened terms that mean “includes, but is not limited to.” The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

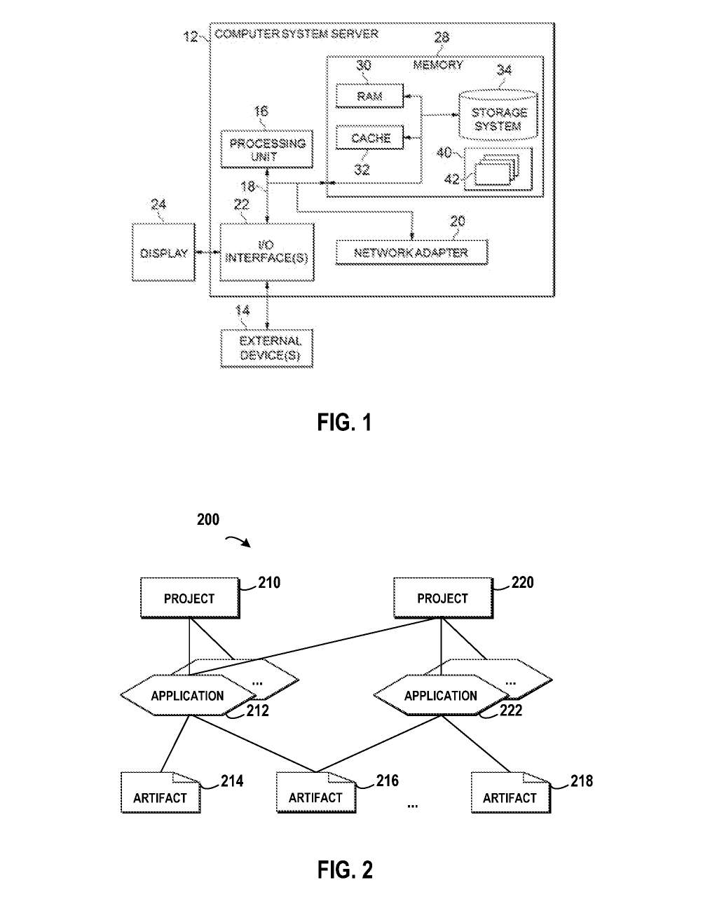

Reference is first made to FIG. 1, in which an example electronic device or computer system/server 12 which is applicable to implement the embodiments of the present invention is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, and the like. One or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

It would be appreciated that the computer system/server 12 illustrated in FIG. 1 is only an example for implementing one embodiment of the present invention. In another embodiment of the present invention, other computing devices may be adopted, for example, if the present invention is implemented in a cloud computing environment, the risk evaluation may be implemented in a computing node in the cloud computing environment.

Some approaches have been developed to manage the time schedules for parallel projects. In some approaches, time schedules may be generated for the projects comprising mutual dependent applications. However, the dependencies between the projects cannot be automatically identified and thus have to be manually inputted. It is known that the dependencies can be identified at the level of artifacts included in different projects. However, as each project may include hundreds or thousands of artifacts, it is hard to transform the dependencies among artifacts to the dependencies among projects.

In view of the above, it is desired to develop a technical solution for evaluating a conflict risk in parallelizing projects. In accordance with one embodiment of the present invention, there is proposed a computer-implemented method. In the method, a dependency risk between a first project and a second project is determined based on an artifact submission history of a historical project. Then an overlap risk between the first and second projects is determined based on time schedules of the first and second projects. Next, a conflict risk between the first and second projects is evaluated based on the dependency risk and the overlap risk. For clarity, meanings of some terms used in the context of the present invention are explained as below.

In software development, an AM project refers to a group of sequential tasks for satisfying one or more requirements. For example, a typical project may include six tasks: a requirement analysis (REQ) task, a design (DES) task, a coding (CODE) task, a unit test (UT) task, a system test (ST) task and a User Acceptance Test (UAT) task. Usually, the sequence of the above tasks is identical to all projects and these tasks are implemented one after another. For the purpose of illustration, projects comprising all the above six tasks are taken as examples for describing embodiments of the present invention. However, it would be appreciated that a project may include more or less tasks based on the scale of the project in a specific situation. For example, the UT task may be omitted in a small project for achieving a simple function.

An application refers to a soft entity for providing a certain function. For example, an application program enabling a user to query his/her credit points in the telecommunication company may be called an application. In the telecommunication company, a project enabling a user to query historical credit points may involve several applications, for example, applications for credit management, user management and bill management. Further, a project for fixing bugs may relate to applications for credit management and user management. With the trend of personalizing service, requirements from the users become increasing complex and diversified, and thus hundreds of application may be involved in one project.

An artifact is a tangible by-product that is produced during software development. Some artifacts describe the function, architecture, and design of software. Other artifacts are concerned with the process of development itself. In the context of the invention, examples of the artifact include, but are not limited to, use cases, class diagrams, and other Unified Modeling Language (UML) models, requirements and design documents, source code files, tables in the database and so on. For the purpose of illustration, source code files will be described as the example artifacts in the context of the present invention. Specifically, in an application programmed in Java language, the *.Java files may be considered as artifacts.

The above paragraphs provide definitions of some terms used in the present invention. Hereinafter, relationships among the above terms will be described with reference to FIG. 2. FIG. 2 schematically illustrates a block diagram of dependencies between two projects in accordance with one embodiment of the present invention. The project 210 and the project 220 represent two AM projects, respectively. In this example, the project 210 involves an application 212 and possibly involves other applications, and the project 220 involves the application 212, an application 222 and possibly involves other applications. Each application may include one or more artifacts. As shown, in this example, the application 212 includes an artifact 214 and an artifact 216, and the application 222 includes the artifact 216, . . . , and an artifact 218. In this situation, the project 210 and the project 220 share the same application 212, and the application 212 and the application 222 share the same artifact 216. For the two projects illustrated in FIG. 2, a dependency exists between the project 210 and the project 220.

In this example, if the project 210 and the project 220 are implemented in parallel, engineers in both projects may possibly update the code in artifact 216 at the same time. Accordingly, conflicts may arise because code updated by the engineer in one project may affect the execution of the code in the other project.

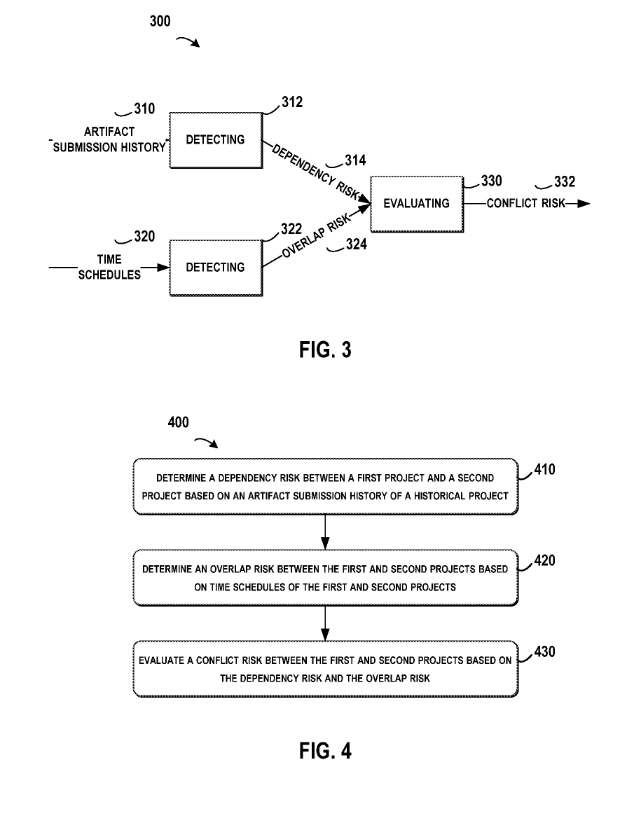

FIG. 3 schematically illustrates a block diagram for evaluating a conflict risk between two projects in accordance with one embodiment of the present invention. The conflict between the two projects is related to various factors. For example, if the two projects share at least one common artifact, then it is determined that the two projects are mutually depended. Moreover, if the two projects are not implemented in parallel, there is no conflict even if the two projects are mutually depended. Hence, both of the artifact dependency and the time overlap between the two projects should be considered.

As shown in FIG. 3, in general, the conflict risk 332 is determined based on an artifact submission history 310 and time schedules 320 of two projects to be evaluated. The artifact submission history 310 indicates at least one artifact submitted in at least one task included in a historical project. The time schedules 320 specify the time periods in which the projects are implemented. A dependency risk 314 between a first project and a second project is detected (312) based on the artifact submission history 310 of the historical project. An overlap risk 324 between the first and second projects is determined (322) based on time schedules 320 of the first and second projects. Next, the conflict risk 332 between the first and second projects is evaluated (330) based on the dependency risk 314 and the overlap risk 324.

Details of the embodiments of the present invention will be described with reference to FIG. 4, which illustrates a flowchart of a method for evaluating a conflict risk between two projects in accordance with one embodiment of the present invention. In Step 410, a dependency risk between a first project and a second project is determined based on an artifact submission history of a historical project. That is, in this step, it is determined whether there is dependency between the first and second projects. For example, in some embodiments, the dependency risk may be determined based on whether the two projects share a common artifact. The common artifact may be identified from the artifact submission history. If the two projects share a common artifact, then it is determined that these two projects have dependency. Alternatively, or in addition, any other rules may be adopted to determine the dependency risk. Example embodiments will be described below.

In Step 420, an overlap risk between the first and second projects is determined based on time schedules of the first and second projects. Usually, the time schedules of the first and second projects have already been created in a project manage tool. Therefore, the time schedules of both the first and second projects may be determined from the project manage tool, for example, from a project Work Breakdown Structure (WBS) generated in the project manage tool.

In Step 430, a conflict risk between the first and second projects is evaluated based on the dependency risk and the overlap risk. In some embodiments, the dependency risk obtained in step 410 and the overlap risk obtained in step 420 may be quantified as numerical values. In such embodiments, the conflict risk is calculated in step 430 based on the numerical values of the dependency risk and the overlap risk in this step.

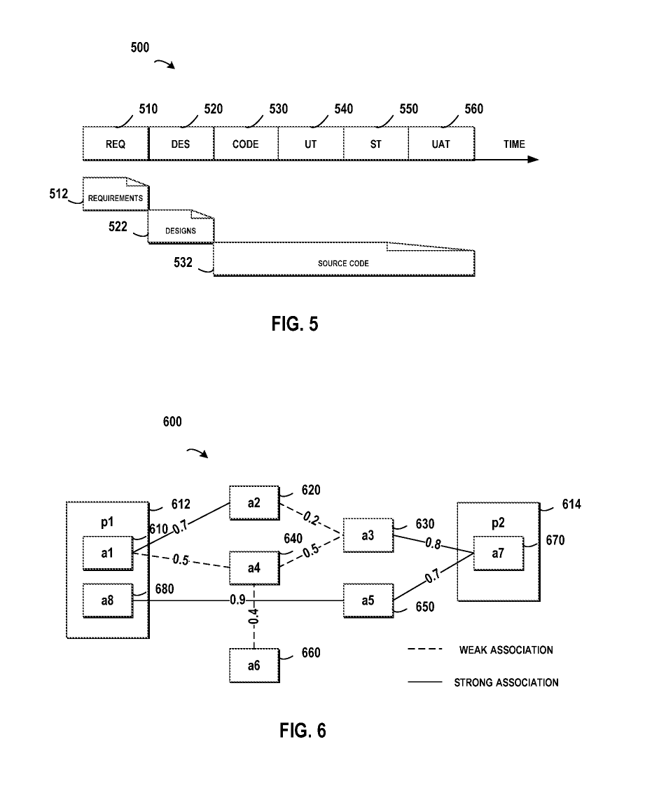

Hereinafter, embodiments of determination of the dependency risk will be described with reference to FIGS. 5-6. Embodiments described in FIGS. 5-6 may be considered as example implementations of step 410 in the method 400. In one embodiment of the present invention, the artifact submission history indicates at least one artifact submitted by at least one task in the historical project. In the context of the present invention, the historical project may be a project launched previously. For example, the historical project may be a project that is finished or a project that is partly implemented. Usually, the engineers revise the artifacts several times in the CODE task and other subsequent test tasks. Therefore, the artifacts in the historical project may have one or more versions. For example, each submission of the artifacts may define a version. According to a traditional experience, if it is determined that two artifacts are submitted by a same version, the two artifacts are very likely to be dependent. Therefore, it is possible to detect the association between two artifacts by measuring the frequency of two artifacts having been submitted by a same task.

FIG. 5 schematically illustrates artifacts submitted in various tasks in a historical project in accordance with one embodiment of the present invention. As described in the above paragraphs, one project may include several sequentially implemented tasks. In the example shown in FIG. 5, there are six tasks 510, 520, . . . , 560 in the historical project. In progress of the project, the engineers may submit various types of artifacts in each of these tasks. For example, in the REQ task 510, artifacts such as requirements 512 collected from the users in forms of text documents may be submitted. In the DES task 520, designs 522 such as preliminary designs and/or detailed designs are submitted. In the CODE task 530, one or more versions of the source code written by the engineer may be submitted. In the subsequent testing tasks 540, 550 and 560, updated versions of the source code may be submitted. Considering the fact that the source code reflects the dependency between the artifacts in the projects to a large extent, the source code will be described as an example of the artifact.

In one embodiment of the present invention, the dependency risk between the first and second projects may be detected in the following way. First, an association between a first artifact associated with the first project and a second artifact associated with the second project may be obtained based on the artifact submission history. Then, the dependency risk may be calculated from the association between the first and second artifacts.

The first and second projects may each include a plurality of artifacts. The source code included in the first and second projects are accumulated gradually. When the first and second projects begin, they include some basic artifacts. Then the engineers in respective projects may add a new artifact and/or update the basic artifacts. Initially, the basic artifacts in respective projects may be considered in determining the dependency risk between the first and second projects. In this situation, the dependency risk between two projects depends on the associations between the artifacts in the first project and the artifacts in the second project. Calculation of the association between two artifacts (for example, artifact a1 and artifact a2) will be described hereinafter.

In one embodiment of the present invention, a first group of tasks in which the first artifact is submitted and a second group of tasks in which the second artifact is submitted may be retrieved from the artifact submission history. Then the association between the first and second artifacts may be calculated based on a similarity coefficient between the first and second groups of tasks.

For example, it is determined from the artifact submission history that al is submitted in a group of historical tasks represented by A1={HT1, HT2 and HT3 }, and that a2 is submitted in another group of historical tasks represented by A2={HT2, HT4}. In this example, the historical tasks HT1-HT4 in the groups A1 and A2 are historical tasks of the historical project. In this embodiment, the association between the artifacts a1 and a2 may be determined based on a Jaccard Index of A1 and A2.

Jaccard Index, which is also known as the Jaccard similarity coefficient, is a statistic used for comparing the similarity and diversity of two sample sets (for example, the above mentioned A1 and A2). The Jaccard Index measures similarity between the sample sets, and is defined as the size of the intersection divided by the size of the union of the sample sets as below:

$$Jaccard Index ( A 1 , A 2 ) = \frac{\vert A 1 ⋂ A 2 \vert}{\vert A 1 ⋃ A 2 \vert} \qquad ( 1 )$$

Continuing the above example, if eight artifacts a1 to a8 are recorded in the artifact submission history, the association between each pair of artifacts may be calculated according to the equation (1). From the artifact submission history, the association between any two artifacts selected from artifacts a1 to a8 may be illustrated in Table 1 as below.

TABLE 1
Associations between Artifacts

| Number | Artifact Pair | Association |
|---|---|---|
| 1 | (a1, a2) | 0.7 |
| 2 | (a1, a4) | 0.5 |
| 3 | (a2, a3) | 0.2 |
| 4 | (a3, a7) | 0.8 |
| 5 | (a3, a4) | 0.5 |
| 6 | (a4, a6) | 0.4 |
| 7 | (a5, a7) | 0.7 |
| 8 | (a5, a8) | 0.9 |

It would be appreciated that Table 1 only illustrates the artifact pairs with association greater than 0 according to equation (1), and the artifact pairs without association relationship are not illustrated herein. By now the associations between each pair of artifacts are obtained, based on the obtained associations, the dependency risk between the first and second projects may be determined.

In one embodiment of the present invention, a connected graph may be built based on the association. Next, in the connected graph, a first set of artifacts that are strongly connected with an artifact associated with the first project may be identified. In addition, a second set of artifacts that are strongly connected with an artifact associated with the second project may be identified. Later, the dependency risk may be calculated based on the first and second sets of the artifacts.

In one embodiment, the connected graph may be built according to the association shown in Table 1. Reference is now made to FIG. 6 which schematically illustrates the connected graph built based on associations in Table 1 in accordance with one embodiment of the present invention. At the beginning of the first project, the first project only includes artifacts a1 and a8, while the second project only includes artifacts a7. Then the connected graph of the first and second projects may be illustrated in FIG. 6. It would be appreciated that the connected graph in FIG. 6 is an example of the connected graph built at the beginning of the first and second projects. With the progress of the first and second projects, if another artifact is involved in then the other artifact may be added into the connected graph.

In this example, in building the connected graph, eight nodes 610, 620, . . . , 680 may be created in the connected graph. At this time, the nodes 610, 620, . . . , 680 represent artifacts a1, a2, a8, respectively. Then, an edge may be added between a pair of nodes based on the association in Table 1. Referring back to Table 1, the association between the artifacts a1 and a2 is 0.7. Therefore an edge with a weight of 0.7 may be created in the connected graph between the node 610 and node 620. Other edges may be created in the connected graph in a similar way, thereby obtaining the finalized graph as shown in FIG. 6.

In some embodiments, it is possible to define a threshold in advance for judging the association degree between two artifacts. A high degree indicates a strong association and a low degree indicates a weak association. As the weak association in the connected graph leads to a weak dependency between the projects, the weak association equivalent to or less than the predefined threshold may be ignored. In this embodiment, the threshold may be set to 0.5, for example. Therefore, a strong association with a weight greater than 0.5 is illustrated with solid line and a weak association with a weight equivalent to or less than 0.5 is illustrated with dash line in FIG. 6. It is to be understood that the threshold can be set to any other suitable value.

From the connected graph in FIG. 6, a set of artifacts that are strongly connected with an artifact associated with the one project may be identified. In order to identify the strongly connected artifacts, the following steps may be repeated with respect to each artifact included in the project. Details will be described below with project p1 as an example

The project p1 in FIG. 6 includes the artifacts a1 and a8. With respect to the artifact a1, as Association (a1, a2)=0.7>0.5, the artifact a2 is strongly connected with a1. As Association (a1, a4)=0.5≦0.5, the artifact a4 is not strongly connected with a1. Further, with respect to the artifact a2 strongly connected with a1, as Association (a2, a3)=0.2≦0.5, the artifact a3 is not strongly connected with a2. Therefore, the artifact strongly connected with al only includes the artifact a2.

Further, with respect to the artifact a8 in the project p1, as Association (a8, a5)=0.9>0.5, the artifact a5 is strongly connected with a8. With respect to the artifact a5 strongly connected with a8, as Association (a5, a7)=0.7>0.5, the artifact a7 is strongly connected with a5. Next, the artifact strongly connected with a7 will be determined With respect to the artifact a7, as Association (a7, a3)=0.8>0.5, the artifact a3 is strongly connected with a7. At this time, the artifacts strongly connected with a8 include the artifacts a5, a7 and a3.

To sum up, all the artifacts being strongly connected with the artifacts included in one project may comprise two types of artifacts: (1) each artifact included in the project; and (2) the artifact being strongly connected with the each artifact in the type (1). Continuing the above example, all the artifacts being strongly connected with the artifacts included in the project p1 are P1={a1, a2, a8, a5, a7, a3}. Based on the above method for obtaining the strongly connected artifacts, the artifacts being strongly connected with the artifacts included in the project p2 are P2={a7, a3, a5, a8}.

In this way, the first set P1 and the second set P2 may be determined. Then, the dependency risk may be calculated based on the first and second sets of artifacts. Specifically, the dependency risk may be calculated according to the Jaccard Index of P1 and P2.

Continuing the above example, the dependency risk between projects p1 and p2 may be calculated as below:

$$Dependency Risk ( p 1 , p 2 ) = Jaccard Index ( P 1 , P 2 ) = \frac{\vert P 1 ⋂ P 2 \vert}{\vert P 1 ⋃ P 2 \vert} = \frac{\vert \{ a 1 , a 2 , a 8 , a 5 , a 7 , a 3 \} ⋂ \{ a 7 , a 3 , a 5 , a 8 \} \vert}{\vert \{ a 1 , a 2 , a 8 , a 5 , a 7 , a 3 \} ⋃ \{ a 7 , a 3 , a 5 , a 8 \} \vert} = \frac{\vert \{ a 7 , a 3 , a 5 , a 8 \} \vert}{\vert \{ a 1 , a 2 , a 8 , a 5 , a 7 , a 3 \} \vert} = \frac{4}{6} = 0.67 \qquad ( 2 )$$

Although the Jaccard Index is described as an example for measuring association between two artifacts and the dependency between two projects, it would be appreciated that other statistical algorithms may be adopted as well. Meanwhile, the above equations (1) and (2) are not intended to limit the algorithms that can be used in the embodiments of the present invention. Appropriate algorithms may be adopted according to demands of specific application environment, so long as these algorithms may measure the association between artifacts and the dependency between the projects.

Now mechanisms for determining the overlap risk between the first and second projects will be described. As described above, the project may include multiple tasks, when two projects are implemented in parallel, the tasks included in the first tasks and the tasks included in the second tasks may possibly be overlapped. In one embodiment of the present invention, in order to determine the overlap risk between the first and second projects, a time overlap between a task in the first project and a task in the second project may be identified. Further, the overlap risk may be determined based on the time overlap and a risk index indicating risk levels between overlapped tasks.

It would be appreciated that at the beginning of the project, the procedure of the project usually follows the time schedule. While during the progress of the project, unexpected events may possibly occur and thus the tasks in the project may be ahead of time or in most cases be delayed. The embodiments of the present invention provide multiple choices to determine the time overlap between two projects. For example, if it is desired to determine the time overlap before launching the projects, an original time schedules for the projects are enough. If delay occurs during proceeding of either of the projects, then the time overlap may be adjusted with the current progress of the first and second projects.

In one embodiment of the present invention, the timetable for implementing the plurality of tasks respectively included in the first and second projects may be extracted from the time schedules. Then the time overlap between the task included in the first project and the task included in the second project may be acquired from the timetable. From the time schedule of the project, the timetable for each task included in the project may be obtained. Usually, the timetable defines a prescheduled time duration for implementing each task. For example, the timetables for projects p1 and p2 are respectively illustrated in Table 2 and Table 3.

TABLE 2
Timetable for Project p1

| | | Beginning | | Duration |
|---|---|---|---|---|
| No. | Task | (week) | End (week) | (week) |
| 1 | REQ | 0 | 3 | 3 |
| 2 | DES | 4 | 7 | 3 |
| 3 | CODE | 8 | 14 | 6 |
| 4 | UT | 15 | 18 | 3 |
| 5 | ST | . . . | . . . | . . . |
| 6 | UAT | . . . | . . . | . . . |

TABLE 3
Timetable for Project p2

| | | Beginning | | Duration |
|---|---|---|---|---|
| No. | Task | (week) | End (week) | (week) |
| 1 | REQ | 0 | 10 | 10 |
| 2 | DES | 11 | 20 | 10 |
| 3 | CODE | . . . | . . . | . . . |
| 4 | UT | . . . | . . . | . . . |
| 5 | ST | . . . | . . . | . . . |
| 6 | UAT | . . . | . . . | . . . |

Considering Table 2 as an example, the column “Task” indicates the name of the task in the project p1, the column “Beginning” indicates the starting time of the task, the column “End” indicates the ending time of the task, and “Duration” indicates the time cost of the task. It would be appreciated that, the above Tables 2 and 3 are not intended to limit the data structure used in the embodiments of the present invention. Appropriate data structures may be adopted according to demands of specific application environment, so long as the data structure can clearly indicate the timetable of each task. For example, as the duration of the task may be determined from the beginning and the end of the task, the column “Duration” may be omitted from Tables 2 and 3 in one embodiment of the present invention.

From Table 2, the REQ task of p1 lasts from week 0 to week 3; from Table 3, the REQ task of p2 lasts from week 0 to week 10, thus these two tasks are overlapped from week 0 to week 3. Further, the CODE task in p1 lasts from week 8 to week 14, and the REQ task of p2 lasts from week 0 to week 10, then these two projects are overlapped from week 8 to week 10. From the above method in this example, the time overlap between a task in the first project and a task in the second project may be determined.

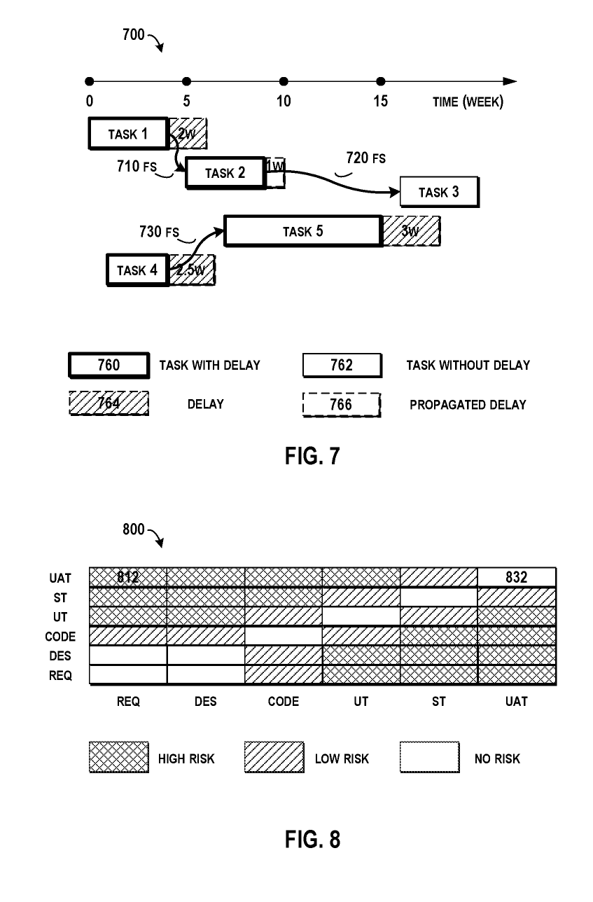

As mentioned above, unexpected events may possibly occur and thus affect the original time schedules. At this time, the current progress of the to-be-evaluated projects may be considered. FIG. 7 schematically illustrates a block diagram for identifying a time overlap between tasks in accordance with one embodiment of the present invention. The horizontal axis in FIG. 7 indicates the time schedule of the projects.

In the legend of FIG. 7, the bold box 760 indicates a task with delay, the box 762 indicates a task without delay, the shaded dash box 764 indicates a delay, and the dash box 766 indicates propagated delay (this type of delay is caused by a delayed task performed before the current task). From the original time schedules of the project, the sequence dependencies among tasks of the project may be obtained and a sequence dependency graph as illustrated in FIG. 7 may be built. In FIG. 7, the types of dependencies between two tasks may comprise Finish-Start (FS), Finish-Finish (FF), Start-Finish (SF) and Start-Start (SS). For example, FS indicates that the first task finishes before the second task starts. It would be appreciated that, the meanings of the above types of dependencies are the same as those used in the field of project management and details of the definition are omitted herein.

In FIG. 7, the tasks 1, 2 and 3 are tasks in the project p1, and the tasks 4-5 are in the project p2. Taking task 1 as an example, the task 1 is delayed by two weeks and thus the task 1 lasts from week 0 to week 6. Because of the delay of the task 1, the task 2 is affected and has a propagated delay of one week. The time table of task 3 does not change and it lasts from week 16 to week 20. Similarly, it is determined that the task 4 in project p2 lasts from week 1 to week 6.5, and the task 5 in project p2 lasts from week 7 to week 18. From the above analysis, it is determined that the task 3 in p1 and the task 5 in p2 are overlapped from week 16 to week 18.

As described above with reference to the block diagram in FIG. 7, the time overlap between two tasks respectively included in two projects to be evaluated may be adjusted. Based on the above disclosure, it is possible to determine whether a task in the first project is overlapped with another task in the second project during proceeding of the projects. If the two tasks are overlapped, then the overlap risk may be obtained based on the time overlap. In one embodiment of the present invention, in response to the occurrence of time overlap between tasks from the two projects to be evaluated, it is determined that the two projects are overlapped. In one embodiment, the dependency risk calculated from equation (2) may be directly taken as an indicator of the degree of the conflict risk between the two projects. If no time overlap occurs between tasks from the two projects, then it is determined that the two projects are not overlapped. Accordingly, the conflict risk between the two projects may be zero.

According to the traditional experience in the field of software development, different types of overlaps provide different contribution to the conflict risk. For example, there may be two overlaps, overlap 1 is a time overlap between the REQ task in the first project and the UAT task in the second project, and overlap 2 is a time overlap between the REQ task in the first project and the REQ task in the second project. Thus the potential conflict risk caused by overlap 1 may be much serious than that caused by overlap 2 according to the traditional experience.

Some embodiments of the present invention further consider where the overlap occurs. FIG. 8 schematically illustrates a risk index indicating risk levels between overlapped tasks in accordance with one embodiment of the present invention. The horizontal axis indicates tasks in the first project and the vertical axis indicates tasks in the second project. In the legend of FIG. 8, the meshed box indicates a high risk, the stripped box indicates a low risk and the box indicates no risk. In this figure, the meshed box 812 indicates the time overlap between the REQ task of the first project and the UAT task of the second project results in a high risk between the first and second projects. For another example, the box 832 indicates that although the time overlap occurs between the UAT task of the first project and the UAT task of the second project, this overlap results no overlap risk between the first and second projects.

In one embodiment of the present invention, the risk level may be quantified as numerical values. For example, the high risk may be set to a weight of “1,” the low risk may be set to a weight of “0.5” and no risk may be indicated by “0.” It would be appreciated that the risk index shown in FIG. 8 are based on statistics and experience in the field of software development, and thus the risk index is suitable for various projects. Moreover, it is to be understood that the distribution of the risk level in FIG. 8 and the weight of “1,” “0.5” and “0” are described only for the purpose of illustration and help those skilled in the art to understand and implement the present invention, without suggesting any limitations as to the scope of the invention.

In one embodiment of the present invention, a method is proposed to measure the contribution of each overlap in evaluating the conflict risk. In this embodiment, the conflict task between two projects may be calculated by considering the contribution caused by each pair of overlapped tasks.

For the purpose of illustration, the two-tuples may be used to represent the overlapped tasks. For example, (REQ, CODE) indicates that the REQ task in one project is overlapped with the CODE task in another project. If (REQ, CODE) and (UT, ST) are found during determining the overlap risk between the first and second projects, then the risk weights of both (REQ, CODE) and (UT, ST) may be considered in evaluating the conflict risk.

It would be appreciated that the order of the tasks in the two-tuples is not considered in the present invention, that is, the meanings of (REQ, CODE) and (CODE, REQ) are identical. In the context of the present invention, there may be a potential overlap risk between the two tasks as long as there is an overlap between two tasks respectively included in two projects.

In one embodiment of the present invention, the overlap risk between two projects may be a sum of weights of the pairs of overlapped tasks. Specifically, the overlap risk between the projects p1 and p2 may be calculated according to equation (3):

Overlap Risk (p1, p2)=Σᵢ₌₁ⁿ Weight(tⱼ, tₖ) (3)

where (tⱼ, tₖ) represents the task tⱼ in one project is overlapped with the task tₖ in another project, and Weight(tⱼ, tₖ) represents the weight of the detected overlap (tⱼ, tₖ)

Continuing the above example, if (REQ, CODE) and (UT, ST) are identified as overlapped tasks with respect to projects p1 and p2, then the overlap risk between projects p1 and p2 may be:

$$Overlap Risk ( p 1 , p 2 ) = {\sum }_{i = 1}^{n} Weight ( {t}_{j} , {t}_{k} ) = Weight ( REQ , CODE ) + Weight ( UT , ST ) = 1 + 0.5 = 1.5$$

In one embodiment of the present invention, the conflict risk between projects p1 and p2 may be evaluated based on the dependency risk and the overlap risk. For example, equation (4) may be adopted:

Conflict Risk (p1, p2)=Dependency Risk(p1, p2)*Overlap Risk (p1, p2) (4)

where Dependency Risk(p1, p2) is calculated according to equation (2), and Overlap Risk (p1, p2) is calculated according to equation (3).

Continuing the above example, if the (REQ, CODE) and (UT, ST) are identified as overlapped tasks, then the conflict risk between projects p1 and p2 may be calculated as below:

$$Conflict Risk ( p 1 , p 2 ) = Dependency Risk ( p 1 , p 2 ) * ( Weight ( REQ , CODE ) + Weight ( UT , ST ) ) = \frac{4}{6} * ( 1 + 0.5 ) = 1$$

In another example, if the (REQ, CODE), (DES, UT) and (UT, ST) are identified as overlapped tasks, then the conflict risk between the projects p1 and p2 may be calculated as below:

$$Conflict Risk ( p 1 , p 2 ) = Dependency Risk ( p 1 , p 2 ) * ( Weight ( REQ , CODE ) + Weight ( DES , UT ) + Weight ( UT , ST ) ) = \frac{4}{6} * ( 1 + 1 + 0.5 ) = 1.67$$

Although the above paragraphs describe the technical solution of the present invention by examples of evaluating the conflict risk between two projects, if there are a plurality of to-be-evaluated projects, then the above technical solution may be implemented with respect to each two of the to-be-evaluated projects.

In one embodiment of the present invention, a threshold may be predefined for judging whether a conflict occurs between two projects. For example, the threshold may be set to 1. At this time, a conflict risk of 0.8 indicates no conflict and a conflict risk 1.5 indicates a conflict.

In the context of the present invention, as overlapped tasks may potentially cause a conflict/unaware modification to the artifacts included in the projects, an additional task may be added into at least one of the projects to discover the impact of the conflict and mitigate the risk. Usually, an EUAT (Extended User Acceptance Test) task may be added into the project. In the EUAT task, the engineers of both projects may discuss the potential impact caused by the conflict, for example, modifications to the artifacts may be shared among engineers in both projects and solution may be worked out to eliminate the potential impact.

In one embodiment of the present invention, the location for inserting the EUAT task may be found by comparing the time schedule of the overlapped tasks. For example, with respect to a pair of overlapped task (Ti, Tj), if the time schedule of Ti in project p1 is later than that of Tj in project p2, then the EUAT task may be inserted into project p1. In details, the EUAT task may start at the end of project p2, and the effort (for example, manpower cost) of the EUAT task may be estimated based on the total effort of the project p1. According to an empirical rule in the field of software development, the effort of the EUAT task may be 5% of the total effort of the project.

In the above example, the REQ task in the project p1 is overlapped with the CODE task in the project p2. Continuing this example, if the REQ task lasts from week 0 to week 10 and the CODE task lasts from week 8 to week 12, then the EUAT task may be inserted into the project p2, and the start time of the EUAT task may be week 10.

It would be appreciated that the above paragraph for generating an EUAT task are described only for the purpose of illustration and help those skilled in the art to understand and implement the present invention. Modifications may be made to the above detailed steps as long as the inserted EUAT task may properly reduce the impact of the conflict between the projects.

In the context of the present invention, the conflict risks among a plurality of projects may be evaluated, and at least one EUAT task may be generated and inserted into one project. In one embodiment of the present invention, for each project with at least one EUAT task inserted, an aggregated EUAT task may be generated to replace the at least one EUAT. Specifically, in the project with multiple EUAT tasks inserted, if the latest EUAT task is earlier than the UAT task, then all the EUAT tasks may be discarded as these EUAT tasks may be covered by the UAT task. Otherwise, the latest EUAT task may be kept and the effort of the latest EUAT task may be updated with a total effort of all the EUAT tasks inserted into the project.

For example, two EUAT tasks e1-e2 are inserted into the project p1, wherein the EUAT task e1 is from week 10 to week 11, the EUAT task e2 is from week 15 to week 16 and the original UAT task is from week 20 to week 22. As the original UAT is later than all the inserted EUAT tasks e1-e2, e1-e2 may be discarded because the original UAT task may cover the EUAT tasks e1-e2. For another example, if the original UAT task is from week 14 to week 15, then e1 may be removed and the effort of e2 may be set to a total effort of both e1 and e2.

In one embodiment of the present invention, the EUAT task may be generated under a certain constraint. In the procedure of software development, usually the investment to a project may vary within a given range. For example, there may be constraints in the aspects of the resource (such as manpower), budgets and time duration. Accordingly, adjustments to the projects should meet these constraints. Specifically, the duration of the adjusted project should not go beyond the predefined time duration for the project, and the effort of the adjusted should not exceed the resource constraint.

According to embodiments of the present invention, the conflict risk among parallel projects may be evaluated. In response to an occurrence of a conflict, the parallel projects may be optimized to mitigate the conflict. With the embodiments of the present invention, the project managers may be aware of potential conflicts between parallel projects. And thus they can make plans in advance of the conflicts instead of remedying the negative impact of the conflicts.

Various embodiments implementing the method of the present invention have been described above with reference to the accompanying drawings. Those skilled in the art may understand that the method may be implemented in software, hardware or a combination of software and hardware. Moreover, those skilled in the art may understand by implementing steps in the above method in software, hardware or a combination of software and hardware, there may be provided an apparatus/system based on the same invention concept. Even if the apparatus/system has the same hardware structure as a general-purpose processing device, the functionality of software contained therein makes the apparatus/system manifest distinguishing properties from the general-purpose processing device, thereby forming an apparatus/system of the various embodiments of the present invention. The apparatus/system described in the present invention comprises several means or modules, the means or modules configured to execute corresponding steps. Upon reading this specification, those skilled in the art may understand how to write a program for implementing actions performed by these means or modules. Since the apparatus/system is based on the same invention concept as the method, the same or corresponding implementation details are also applicable to means or modules corresponding to the method. As detailed and complete description has been presented above, the apparatus/system is not detailed below.

According to one embodiment of the present invention, a computing system is proposed. The computing system comprises a computer processor coupled to a computer-readable memory unit, the memory unit comprising instructions that when executed by the computer processor implements a method. In the method, a dependency risk between a first project and a second project is determined based on an artifact submission history of a historical project. Then an overlap risk between the first and second projects is determined based on time schedules of the first and second projects. Next, a conflict risk between the first and second projects is evaluated based on the dependency risk and the overlap risk.

In one embodiment of the present invention, the dependency risk between the first and second projects may be determined by the following steps. First, an association between a first artifact associated with the first project and a second artifact associated with the second project may be obtained based on the artifact submission history, the first and second artifacts being indicated by the artifact submission history; then the dependency risk may be calculated from the association between the first and second artifacts.

In one embodiment of the present invention, a first group of tasks in which the first artifact is submitted and a second group of tasks in which the second artifact is submitted may be retrieved from the artifact submission history. Then the association between the first and second artifacts may be calculated based on a similarity coefficient between the first and second groups of tasks.

In one embodiment of the present invention, during calculating the dependency risk, a connected graph may be built based on the association. Then, a first set of artifacts that are strongly connected with an artifact in the first project may be identified from the connected graph; and a second set of artifacts that are strongly connected with an artifact in the second project may be identified from the connected graph. Next, the dependency risk may be calculated based on the first and second sets of artifacts.

In one embodiment of the present invention, a time overlap between a first task included in the first project and a second task included in the second project may be identified; and then the overlap risk may be determined based on the detected time overlap and a risk index indicating risk levels between overlapped tasks.

In one embodiment of the present invention, a timetable for performing the first and second tasks may be extracted from the time schedules. Then the time overlap may be identified based on the timetable.

In one embodiment of the present invention, the time overlap may be adjusted with current a progress of at least one of the first and second projects.

In one embodiment of the present invention, an extended task may be inserted into at least one of the first and second projects in response to the conflict risk exceeding a threshold.

In one embodiment of the present invention, the extended Test may be modified under at least one constraint of manpower, budget and time duration.

According to one embodiment of the present invention, a computer program product is proposed. The computer program product is tangibly stored on a non-transient machine-readable medium and comprising machine-executable instructions. The instructions, when executed on an electronic device, cause the electronic device to: determine a dependency risk between a first project and a second project based on an artifact submission history of a historical project; determine an overlap risk between the first and second projects based on time schedules of the first and second projects; and evaluate a conflict risk between the first and second projects based on the dependency risk and the overlap risk.

In one embodiment of the present invention, the artifact submission history indicates at least one artifact submitted in at least one task included in the historical project, and the instructions further cause the electronic device to: obtain an association between a first artifact associated with the first project and a second artifact associated with the second project based on the artifact submission history, the first and second artifacts being indicated by the artifact submission history; and calculate the dependency risk from the association between the first and second artifacts.

In one embodiment of the present invention, the instructions further cause the electronic device to: retrieve, from the artifact submission history, a first group of tasks in which the first artifact is submitted and a second group of tasks in which the second artifact is submitted; and calculate the association between the first and second artifacts based on a similarity coefficient between the first and second groups of tasks.

In one embodiment of the present invention, the instructions further cause the electronic device to: build a connected graph based on the association; identify, from the connected graph, a first set of artifacts that are strongly connected with an artifact associated with the first project; identify, from the connected graph, a second set of artifacts that are strongly connected with an artifact associated with the second project; and calculate the dependency risk based on the first and second sets of artifacts.

In one embodiment of the present invention, the instructions further cause the electronic device to: identify a time overlap between a first task included in the first project and a second task included in the second project; and determine the overlap risk based on the time overlap and a risk index indicating a risk level between overlapped tasks.

In one embodiment of the present invention, the instructions further cause the electronic device to: extract, from the time schedules, a timetable for performing the first and second tasks; and identify the time overlap based on the timetable.

In one embodiment of the present invention, the instructions further cause the electronic device to: adjust the time overlap with a progress of at least one of the first and second projects.

In one embodiment of the present invention, the instructions further cause the electronic device to: in response to the conflict risk exceeding a threshold, insert an extended task into at least one of the first and second projects.

In one embodiment of the present invention, the instructions further cause the electronic device to: modify the extended task under at least one constraint of manpower, budget and time duration.

Moreover, the system may be implemented by various manners, including software, hardware, firmware or a random combination thereof. For example, in some embodiments, the apparatus may be implemented by software and/or firmware. Alternatively or additionally, the system may be implemented partially or completely based on hardware, for example, one or more units in the system may be implemented as an integrated circuit (IC) chip, an application-specific integrated circuit (ASIC), a system on chip (SOC), a field programmable gate array (FPGA), etc. The scope of the present intention is not limited to this aspect.

The present invention may be a system, an apparatus, a device, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams illustrate the architecture, functionality, and operation of possible implementations of systems, methods and computer program products according to various embodiments of the present invention. In this regard, each block in the flowchart or block diagrams may represent a module, snippet, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
determining a dependency risk between a first project and a second project based on an artifact submission history of a historical project;
determining an overlap risk between the first and second projects based on time schedules of the first and second projects; and
evaluating a conflict risk between the first and second projects based on the dependency risk and the overlap risk.

2. The method of claim 1, wherein determining the dependency risk between the first and second projects comprises:
obtaining an association between a first artifact associated with the first project and a second artifact associated with the second project based on the artifact submission history, the first and second artifacts being indicated by the artifact submission history; and
calculating the dependency risk from the association between the first and second artifacts.

3. The method of claim 2, wherein obtaining the association between the first and second artifacts comprises:
retrieving, from the artifact submission history, a first group of tasks in which the first artifact is submitted and a second group of tasks in which the second artifact is submitted; and
calculating the association between the first and second artifacts based on a similarity coefficient between the first and second groups of tasks.

4. The method of claim 2, wherein calculating the dependency risk from the association between the first and second artifacts comprises:
building a connected graph based on the association;
identifying, from the connected graph, a first set of artifacts that are strongly connected with an artifact associated with the first project;
identifying, from the connected graph, a second set of artifacts that are strongly connected with an artifact associated with the second project; and
calculating the dependency risk based on the first and second sets of artifacts.

5. The method of claim 1, wherein determining the overlap risk between the first and second projects comprises:
identifying a time overlap between a first task included in the first project and a second task included in the second project; and
determining the overlap risk based on the time overlap and a risk index indicating a risk level between overlapped tasks.

6. The method of claim 5, wherein identifying the time overlap comprises:
extracting, from the time schedules, a timetable for performing the first and second tasks; and
identifying the time overlap based on the timetable.

7. The method of claim 6, further comprising:
adjusting the time overlap with a progress of at least one of the first and second projects.

8. The method of claim 1, further comprising:
in response to the conflict risk exceeding a threshold, inserting an extended task into at least one of the first and second projects.

9. The method of claim 8, further comprising:
modifying the extended task under at least one constraint of manpower, budget and time duration.
